(19) United States
(12) Patent Application Publication
(10) Pub. No.: US 2017/0220520 A1
(43) Pub. Date: Aug. 3, 2017

(54) DETERMINING AN OPERATION STATE WITHIN A COMPUTING SYSTEM WITH MULTI-CORE PROCESSING DEVICES

(71) Applicant: KnuEdge Incorporated, San Diego, CA (US)

(72) Inventors: Douglas Meyer, El Cajon, CA (US); Andrew J. White, Austin, TX (US)

(73) Assignee: KnuEdge Incorporated, San Diego, CA (US)

(21) Appl. No.: 15/010,091

(22) Filed: Jan. 29, 2016

(51) Int. Cl. G06F 15/80

(52) U.S. Cl. CPC G06F 15/80

(57) ABSTRACT

Systems and methods for operating a processing device are provided. A method may comprise transmitting data on the processing device, monitoring state information for a plurality of buffers on the processing device for the transmitted data, aggregating the monitored state information, starting a timer in response to determining that all buffers of the plurality of buffers are empty and asserting a drain state for the plurality of buffers in response to all buffers of the plurality of buffers remained empty for the duration of the timer.

### FIELD OF THE DISCLOSURE

The present disclosure relates to monitoring an operation state within a computing system that contains a plurality of multi-core processing devices, and, in particular, capturing meaningful state information indicating that processing or movement of data has been completed in a network of interest within the computing system.

### BACKGROUND

Information-processing systems are computing systems that process electronic and/or digital information. Typical information-processing system may include multiple processing elements, such as multiple single core computer processors or one or more multi-core computer processors capable of concurrent and/or independent operation. Such systems may be referred to as multi-processor or multi-core processing systems.

In a multi-core processing system, data may be loaded to destination processing elements for processing. In epoch-based algorithms, such as in computational fluid dynamics (CFD) or neural models, the amount of data being sent is known ahead of time, and counted wait counters can be used to indicate when the expected number of packets have arrived. These types of applications can be characterized as having fully deterministic data movement that can be calculated either at compile time or at run time, prior to the start of the data movement. In other applications (e.g. radix sort), however, the amount of data arriving at any given memory is not known at compile time or cannot be calculated prior to storing. Moreover, data may be transmitted in a computing system without guarantee of an orderly delivery, especially if transmitted to different destinations. Therefore, there is a need in the art for capturing meaningful state information indicating that processing of data or data movement has finished in a network of interest within a computing system.

### SUMMARY

The present disclosure provides systems, methods and apparatuses for operating processing elements in a computing system. In one aspect of the disclosure, a processing device may be provided. The processing device may comprise a plurality of processing elements organized into a plurality of clusters. A first cluster of the plurality of clusters may comprise a plurality of interconnect buffers coupled to a subset of the plurality of processing elements within the first cluster. Each interconnect buffer may have a respective interconnect buffer signal line and may be configured to assert the respective interconnect buffer signal line to indicate a state of the respective interconnect buffer. The first cluster may further comprise a cluster state circuit that has inputs coupled to the interconnect buffer signal lines and an output indicating a state of the first cluster, and a cluster timer with an input coupled to the output of the cluster state circuit. The cluster timer may be configured to (i) start counting when all buffers of the plurality of interconnect buffers become empty, and (ii) assert a drain state when all buffers of the plurality of interconnect buffers remain empty for a duration of the cluster timer.

In another aspect of the disclosure, a method of operating a processing device may be provided. The method may comprise transmitting data on the processing device, monitoring state information for a plurality of buffers on the processing device, determining that a drain condition is satisfied using the state information for the plurality of buffers, starting a timer in response to determining that the drain condition is satisfied and asserting a drain state in response to the drain condition remaining satisfied for a duration of the timer.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1A is a block diagram of an exemplary computing system according to the present disclosure.

FIG. 1B is a block diagram of an exemplary processing device according to the present disclosure.

FIG. 2A is a block diagram of topology of connections of an exemplary computing system according to the present disclosure.

FIG. 2B is a block diagram of topology of connections of another exemplary computing system according to the present disclosure.

FIG. 3A is a block diagram of an exemplary cluster according to the present disclosure.

FIG. 3B is a block diagram of an exemplary super cluster according to the present disclosure.

FIG. 4 is a block diagram of an exemplary processing engine according to the present disclosure.

FIG. 5 is a block diagram of an exemplary packet according to the present disclosure.

FIG. 6 is a flow diagram showing an exemplary process of addressing a computing resource using a packet according to the present disclosure.

FIG. 7 is a block diagram of an exemplary processing device according to the present disclosure.

FIG. 8 is a block diagram of an exemplary cluster according to the present disclosure.

FIG. 9 is a block diagram of drain state monitoring circuit for an exemplary cluster according to the present disclosure.

FIG. 10 is a block diagram of drain state monitoring circuit for an exemplary processing device according to the present disclosure.

FIG. 11 is a block diagram of drain state output circuit for an exemplary processing device according to the present disclosure.

FIG. 12 is a block diagram of drain state monitoring circuit for an exemplary processing board according to the present disclosure.

FIG. 13 is a flow diagram showing an exemplary process of monitoring drain state information for a network of interest according to the present disclosure.

### DETAILED DESCRIPTION

Certain illustrative aspects of the systems, apparatuses, and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order to avoid unnecessarily obscuring the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

Embodiments according to the present disclosure may determine whether and/or when memory state (e.g., a single memory or a set of memories) has been transitioned to a desired state without implementing any sort of memory coherency logic to track memory state. For example, an embodiment may include one or more multi-core processors in which a plurality of processing cores may share a single memory or a set of memories but the one or more multi-core processors do not have any sort any sort of memory coherency logic. This is in contrast to a conventional multi-processor system, such as a symmetric multiprocessing (SMP) system, in which the memory and cache coherency may be used to enforce the idea that any given address has an “owner” at every instant in time.

Moreover, embodiments according to the present disclosure may determine whether and/or when memory state has been transitioned to a desired state without knowing in advance how many packets may be transmitted or without guaranteed packet ordering. For example, an embodiment may include one or more processors and at least some of the one or more processors may include a plurality of processing cores sharing a single memory or a set of memories. The various components of the embodiment may communicate data by packets, which the receiving component does not know how many would be transmitted or may be received out of the order they were transmitted.

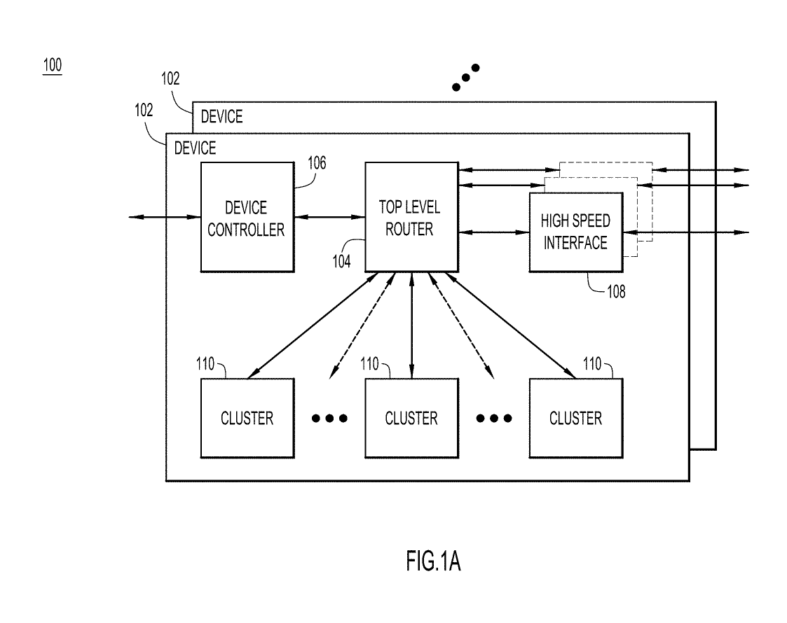

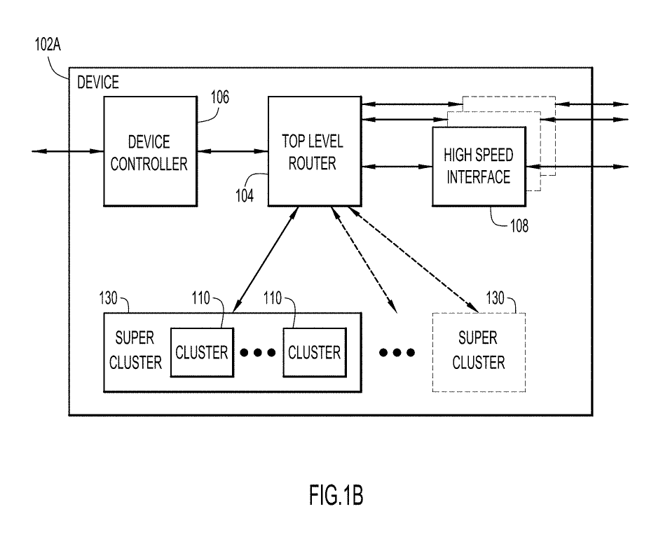

FIG. 1A shows an exemplary computing system 100 according to the present disclosure. The computing system 100 may comprise at least one processing device 102. A typical computing system 100, however, may comprise a plurality of processing devices 102. Each processing device 102, which may also be referred to as device 102, may comprise a router 104, a device controller 106, a plurality of high speed interfaces 108 and a plurality of clusters 110. The router 104 may also be referred to as a top level router or a level one router. Each cluster 110 may comprise a plurality of processing engines to provide computational capabilities for the computing system 100. The high speed interfaces 108 may comprise communication ports to communicate data outside of the device 102, for example, to other devices 102 of the computing system 100 and/or interfaces to other computing systems. Unless specifically expressed otherwise, data as used herein may refer to both program code and pieces of information upon which the program code operates.

In some implementations, the processing device 102 may include 2, 4, 8, 16, 32 or another number of high speed interfaces 108. Each high speed interface 108 may implement a physical communication protocol. In one non-limiting example, each high speed interface 108 may implement the media access control (MAC) protocol, and thus may have a unique MAC address associated with it. The physical communication may be implemented in a known communication technology, for example, Gigabit Ethernet, or any other existing or future-developed communication technology. In one non-limiting example, each high speed interface 108 may implement bi-directional high-speed serial ports, such as 10 Giga bits per second (Gbps) serial ports. Two processing devices 102 implementing such high speed interfaces 108 may be directly coupled via one pair or multiple pairs of the high speed interfaces 108, with each pair comprising one high speed interface 108 on one processing device 102 and another high speed interface 108 on the other processing device 102.

Data communication between different computing resources of the computing system 100 may be implemented using routable packets. The computing resources may comprise device level resources such as a device controller 106, cluster level resources such as a cluster controller or cluster memory controller, and/or the processing engine level resources such as individual processing engines and/or individual processing engine memory controllers. An exemplary packet 140 according to the present disclosure is shown in FIG. 5. The packet 140 may comprise a header 142 and a payload 144. The header 142 may include a routable destination address for the packet 140. The router 104 may be a top-most router configured to route packets on each processing device 102. The router 104 may be a programmable router. That is, the routing information used by the router 104 may be programmed and updated. In one non-limiting embodiment, the router 104 may be implemented using an address resolution table (ART) or Look-up table (LUT) to route any packet it receives on the high speed interfaces 108, or any of the internal interfaces interfacing the device controller 106 or clusters 110. For example, depending on the destination address, a packet 140 received from one cluster 110 may be routed to a different cluster 110 on the same processing device 102, or to a different processing device 102; and a packet 140 received from one high speed interface 108 may be routed to a cluster 110 on the processing device or to a different processing device 102.

The device controller 106 may control the operation of the processing device 102 from power on through power down. The device controller 106 may comprise a device controller processor, one or more registers and a device controller memory space. The device controller processor may be any existing or future-developed microcontroller. In one embodiment, for example, an ARM® Cortex M0 microcontroller may be used for its small footprint and low power consumption. In another embodiment, a bigger and more powerful microcontroller may be chosen if needed. The one or more registers may include one to hold a device identifier (DEVID) for the processing device 102 after the processing device 102 is powered up. The DEVID may be used to uniquely identify the processing device 102 in the computing system 100. In one non-limiting embodiment, the DEVID may be loaded on system start from a non-volatile storage, for example, a non-volatile internal storage on the processing device 102 or a non-volatile external storage. The device controller memory space may include both read-only memory (ROM) and random access memory (RAM). In one non-limiting embodiment, the ROM may store bootloader code that during a system start may be executed to initialize the processing device 102 and load the remainder of the boot code through a bus from outside of the device controller 106. The instructions for the device controller processor, also referred to as the firmware, may reside in the RAM after they are loaded during the system start.

The registers and device controller memory space of the device controller 106 may be read and written to by computing resources of the computing system 100 using packets. That is, they are addressable using packets. As used herein, the term “memory” may refer to RAM, SRAM, DRAM, eDRAM, SDRAM, volatile memory, non-volatile memory, and/or other types of electronic memory. For example, the header of a packet may include a destination address such as DEVID:PADDR, of which the DEVID may identify the processing device 102 and the PADDR may be an address for a register of the device controller 106 or a memory location of the device controller memory space of a processing device 102. In some embodiments, a packet directed to the device controller 106 may have a packet operation code, which may be referred to as packet opcode or just opcode to indicate what operation needs to be performed for the packet. For example, the packet operation code may indicate reading from or writing to the storage location pointed to by PADDR. It should be noted that the device controller 106 may also send packets in addition to receiving them. The packets sent by the device controller 106 may be self-initiated or in response to a received packet (e.g., a read request). Self-initiated packets may include for example, reporting status information, requesting data, etc.

In one embodiment, a plurality of clusters 110 on a processing device 102 may be grouped together. FIG. 1B shows a block diagram of another exemplary processing device 102A according to the present disclosure. The exemplary processing device 102A is one particular embodiment of the processing device 102. Therefore, the processing device 102 referred to in the present disclosure may include any embodiments of the processing device 102, including the exemplary processing device 102A. As shown on FIG. 1B, a plurality of clusters 110 may be grouped together to form a super cluster 130 and an exemplary processing device 102A may comprise a plurality of such super clusters 130. In one embodiment, a processing device 102 may include 2, 4, 8, 16, 32 or another number of clusters 110, without further grouping the clusters 110 into super clusters. In another embodiment, a processing device 102 may include 2, 4, 8, 16, 32 or another number of super clusters 130 and each super cluster 130 may comprise a plurality of clusters.

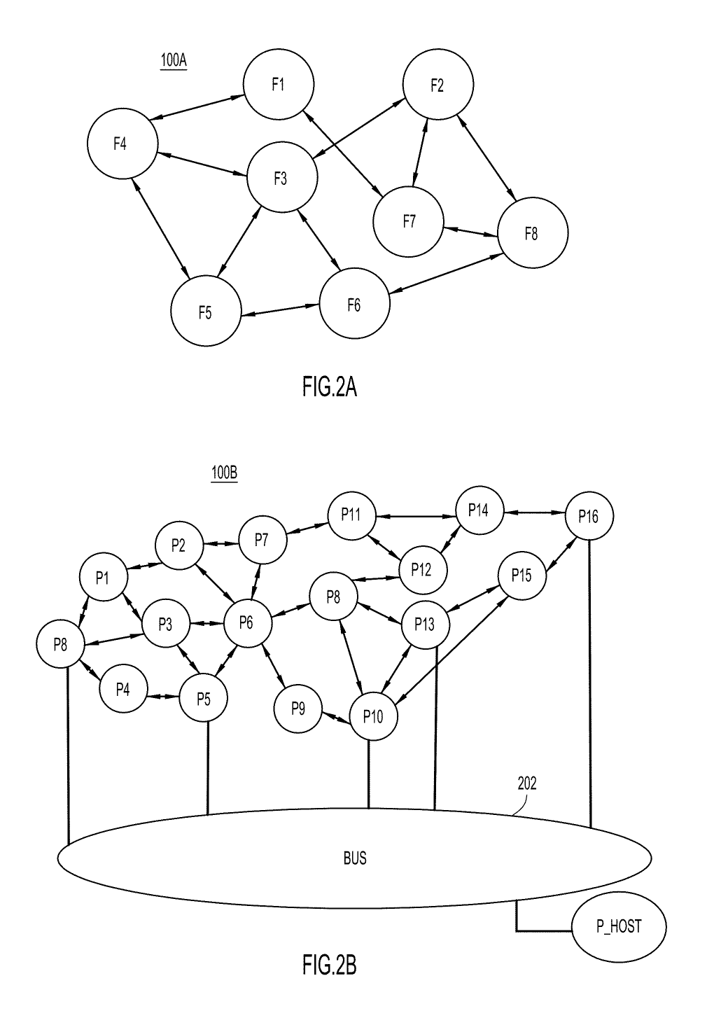

FIG. 2A shows a block diagram of an exemplary computing system 100A according to the present disclosure. The computing system 100A may be one exemplary embodiment of the computing system 100 of FIG. 1A. The computing system 100A may comprise a plurality of processing devices 102 designated as F1, F2, F3, F4, F5, F6, F7 and F8. As shown in FIG. 2A, each processing device 102 may be directly coupled to one or more other processing devices 102. For example, F4 may be directly coupled to F1, F3 and F5; and F7 may be directly coupled to F1, F2 and F8. Within computing system 100A, one of the processing devices 102 may function as a host for the whole computing system 100A. The host may have a unique device ID that every processing devices 102 in the computing system 100A recognizes as the host. For example, any processing devices 102 may be designated as the host for the computing system 100A. In one non-limiting example, F1 may be designated as the host and the device ID for F1 may be set as the unique device ID for the host.

In another embodiment, the host may be a computing device of a different type, such as a computer processor known in the art (for example, an ARM® Cortex or Intel® x86 processor) or any other existing or future-developed processors. In this embodiment, the host may communicate with the rest of the system 100A through a communication interface, which may represent itself to the rest of the system 100A as the host by having a device ID for the host.

The computing system 100A may implement any appropriate techniques to set the DEVIDs, including the unique DEVID for the host, to the respective processing devices 102 of the computing system 100A. In one exemplary embodiment, the DEVIDs may be stored in the ROM of the respective device controller 106 for each processing devices 102 and loaded into a register for the device controller 106 at power up. In another embodiment, the DEVIDs may be loaded from an external storage. In such an embodiment, the assignments of DEVIDs may be performed offline, and may be changed offline from time to time or as appropriate. Thus, the DEVIDs for one or more processing devices 102 may be different each time the computing system 100A initializes. Moreover, the DEVIDs stored in the registers for each device controller 106 may be changed at runtime. This runtime change may be controlled by the host of the computing system 100A. For example, after the initialization of the computing system 100A, which may load the pre-configured DEVIDs from ROM or external storage, the host of the computing system 100A may reconfigure the computing system 100A and assign different DEVIDs to the processing devices 102 in the computing system 100A to overwrite the initial DEVIDs in the registers of the device controllers 106.

FIG. 2B is a block diagram of a topology of another exemplary system 100B according to the present disclosure. The computing system 100B may be another exemplary embodiment of the computing system 100 of FIG. 1 and may comprise a plurality of processing devices 102 (designated as P1 through P16 on FIG. 2B), a bus 202 and a processing device P_Host. Each processing device of P1 through P16 may be directly coupled to another processing device of P1 through P16 by a direct link between them. At least one of the processing devices P1 through P16 may be coupled to the bus 202. As shown in FIG. 2B, the processing devices P8, P5, P10, P13 and P16 may be coupled to the bus 202. The processing device P_Host may be coupled to the bus 202 and may be designated as the host for the computing system 100B. In the exemplary system 100B, the host may be a computer processor known in the art (for example, an ARM® Cortex or Intel® x86 processor) or any other existing or future-developed processors. The host may communicate with the rest of the system 100B through a communication interface coupled to the bus and may represent itself to the rest of the system 100B as the host by having a device ID for the host.

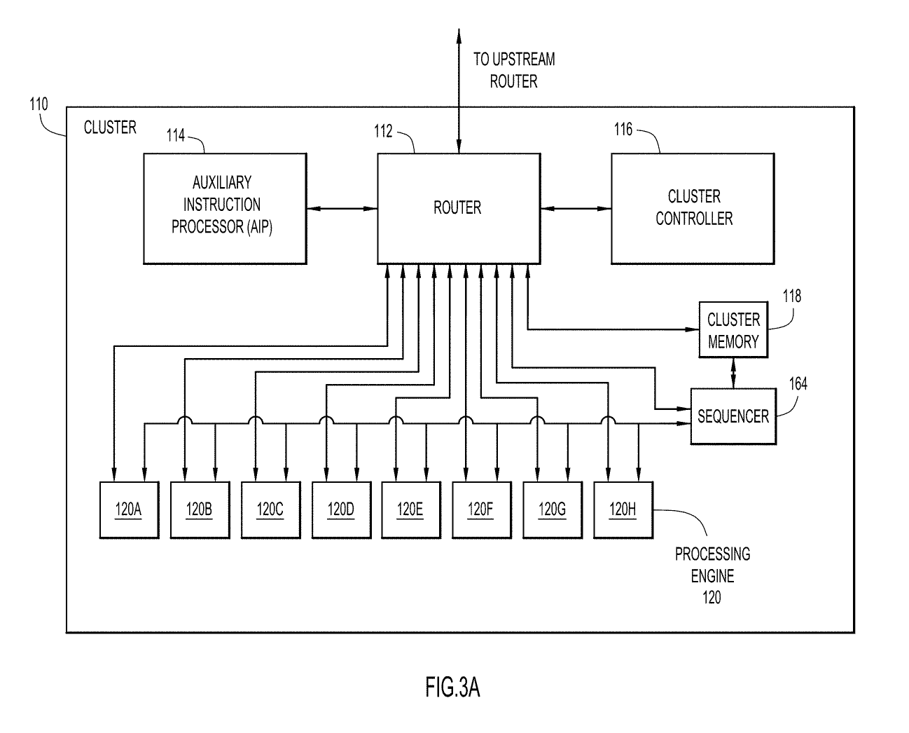

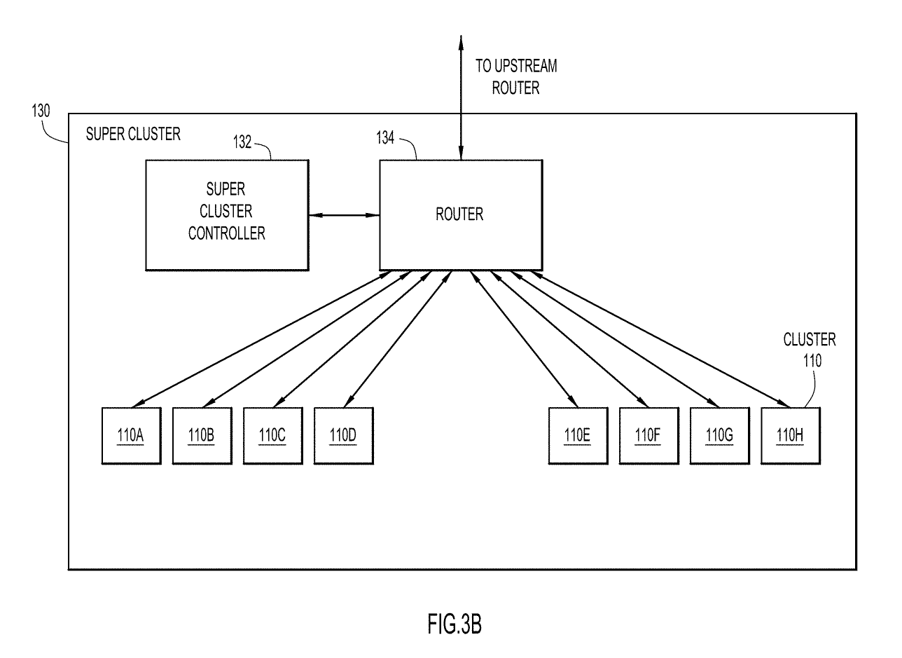

FIG. 3A shows a block diagram of an exemplary cluster 110 according to the present disclosure. The exemplary cluster 110 may comprise a router 112, a cluster controller 116, an auxiliary instruction processor (AIP) 114, a cluster memory 118, a data sequencer 164 and a plurality of processing engines 120. The router 112 may be coupled to an upstream router to provide interconnection between the upstream router and the cluster 110. The upstream router may be, for example, the router 104 of the processing device 102 if the cluster 110 is not part of a super cluster 130. In some embodiments, the various interconnect between these different components of the cluster 110 may comprise interconnect buffers.

The exemplary operations to be performed by the router 112 may include receiving a packet destined for a resource within the cluster 110 from outside the cluster 110 and/or transmitting a packet originating within the cluster 110 destined for a resource inside or outside the cluster 110. A resource within the cluster 110 may be, for example, the cluster memory 118 or any of the processing engines 120 within the cluster 110. A resource outside the cluster 110 may be, for example, a resource in another cluster 110 of the computer device 102, the device controller 106 of the processing device 102, or a resource on another processing device 102. In some embodiments, the router 112 may also transmit a packet to the router 104 even if the packet may target a resource within itself. In one embodiment, the router 104 may implement a loopback path to send the packet back to the originating cluster 110 if the destination resource is within the cluster 110.

The cluster controller 116 may send packets, for example, as a response to a read request, or as unsolicited data sent by hardware for error or status report. The cluster controller 116 may also receive packets, for example, packets with opcodes to read or write data. In one embodiment, the cluster controller 116 may be any existing or future-developed microcontroller, for example, one of the ARM® Cortex-M microcontroller and may comprise one or more cluster control registers (CCRs) that provide configuration and control of the cluster 110. In another embodiment, instead of using a microcontroller, the cluster controller 116 may be custom made to implement any functionalities for handling packets and controlling operation of the router 112. In such an embodiment, the functionalities may be referred to as custom logic and may be implemented, for example, by a field programmable gate array (FPGA) or other specialized circuitry. Regardless of whether it is a microcontroller or implemented by custom logic, the cluster controller 116 may implement a fixed-purpose state machine encapsulating packets and memory access to the CCRs.

Each cluster memory 118 may be part of the overall addressable memory of the computing system 100. That is, the addressable memory of the computing system 100 may include the cluster memories 118 of all clusters of all devices 102 of the computing system 100. The cluster memory 118 may be a part of the main memory shared by the computing system 100. In some embodiments, any memory location within the cluster memory 118 may be addressed by any processing engine within the computing system 100 by a physical address. The physical address may be a combination of the DEVID, a cluster identifier (CLSID) and a physical address location (PADDR) within the cluster memory 118, which may be formed as a string of bits, such as, for example, DEVID:CLSID:PADDR. The DEVID may be associated with the device controller 106 as described above and the CLSID may be a unique identifier to uniquely identify the cluster 110 within the local processing device 102. It should be noted that in at least some embodiments, each register of the cluster controller 116 may also be assigned a physical address (PADDR). Therefore, the physical address DEVID:CLSID:PADDR may also be used to address a register of the cluster controller 116, in which PADDR may be an address assigned to the register of the cluster controller 116.

In some other embodiments, any memory location within the cluster memory 118 may be addressed by any processing engine within the computing system 100 by a virtual address. The virtual address may be a combination of a DEVID, a CLSID and a virtual address location (ADDR), which may be formed as a string of bits, such as, for example, DEVID:CLSID:ADDR. The DEVID and CLSID in the virtual address may be the same as in the physical addresses.

In one embodiment, the width of ADDR may be specified by system configuration. For example, the width of ADDR may be loaded into a storage location convenient to the cluster memory 118 during system start and/or changed from time to time when the computing system 100 performs a system configuration. To convert the virtual address to a physical address, the value of ADDR may be added to a base physical address value (BASE). The BASE may also be specified by system configuration as the width of ADDR and stored in a location convenient to a memory controller of the cluster memory 118. In one example, the width of ADDR may be stored in a first register and the BASE may be stored in a second register in the memory controller. Thus, the virtual address DEVID:CLSID:ADDR may be converted to a physical address as DEVID:CLSID:ADDR+BASE. Note that the result of ADDR+BASE has the same width as the longer of the two.

The address in the computing system 100 may be 8 bits, 16 bits, 32 bits, 64 bits, or any other number of bits wide. In one non-limiting example, the address may be 32 bits wide. The DEVID may be 10, 15, 20, 25 or any other number of bits wide. The width of the DEVID may be chosen based on the size of the computing system 100, for example, how many processing devices 102 the computing system 100 has or may be designed to have. In one non-limiting example, the DEVID may be 20 bits wide and the computing system 100 using this width of DEVID may contain up to 2²⁰ processing devices 102. The width of the CLSID may be chosen based on how many clusters 110 the processing device 102 may be designed to have. For example, the CLSID may be 3, 4, 5, 6, 7, 8 bits or any other number of bits wide. In one non-limiting example, the CLSID may be 5 bits wide and the processing device 102 using this width of CLSID may contain up to 2⁵ clusters. The width of the PADDR for the cluster level may be 20, 30 or any other number of bits. In one non-limiting example, the PADDR for the cluster level may be 27 bits and the cluster 110 using this width of PADDR may contain up to 2²⁷ memory locations and/or addressable registers. Therefore, in some embodiments, if the DEVID may be 20 bits wide, CLSID may be 5 bits and PADDR may have a width of 27 bits, a physical address DEVID:CLSID:PADDR or DEVID:CLSID:ADDR+BASE may be 52 bits.

For performing the virtual to physical memory conversion, the first register (ADDR register) may have 4, 5, 6, 7 bits or any other number of bits. In one non-limiting example, the first register may be 5 bits wide. If the value of the 5 bits register is four (4), the width of ADDR may be 4 bits; and if the value of 5 bits register is eight (8), the width of ADDR will be 8 bits. Regardless of ADDR being 4 bits or 8 bits wide, if the PADDR for the cluster level may be 27 bits then BASE may be 27 bits, and the result of ADDR+BASE may still be a 27 bits physical address within the cluster memory 118.

The processing engines 120A to 120H of each cluster 110 may share the data sequencer 164 that executes a data “feeder” program to push data directly to the processing engines 120A-120H. The data sequencer 164 uses an instruction set in a manner similar to that of a CPU, but the instruction set may be optimized for rapidly retrieving data from memory stores within the cluster and pushing them directly to local processing engines. The data sequencer 164 is also capable of pushing data to other destinations outside of the cluster.

The data feeder program may be closely associated with tasks running on local and remote processing engines. Synchronization may be performed via fast hardware events, direct control of execution state, and other means. Data pushed by the data sequencer 164 travels as flit packets within the processing device interconnect. The data sequencer 164 may comprise a series of feeder queues and place the outgoing flit packets into the feeder queues where the flit packets are buffered until the interconnect is able to transport them toward their destination. In one embodiment, there are separate outgoing feeder queues to unique paths to each processing engine 120 as well as a unique feeder queue for flit packets each with a destination outside of the cluster.

It should be noted that the data sequencer 164 does not replace a direct memory access (DMA) engine. In one embodiment, although not shown, each cluster 110 may also include one or more DMA engines. For example, the number of DMA engines in a cluster may depend on the number of memory blocks used such that one DMA engine is used for access certain memory block(s), and another DMA engine may be used for accessing other memory block(s). These one or more DMA engines may be identical: they do not run a program of any sort but only execute as a result of a DMA packet being sent to the particular memory to which they are associated. The DMA engines may use the same paths that normal packet reads/writes use. For example, if the data sequencer 164 sends a packet (or constructs a packet) from the memory, it uses an appropriate feeder queue instead of the memory outbound port. In contrast, if a DMA read packet is sent to the memory, then the associated DMA engine performs the requested DMA operation (it does not run a program) and sends the outbound flits via the memory's outbound path (the same path that would be used for a flit read of the memory).

FIG. 3A shows that a cluster 110 may comprise one cluster memory 118. In another embodiment, a cluster 110 may comprise a plurality of cluster memories 118 that each may comprise a memory controller and a plurality of memory banks, respectively. Moreover, in yet another embodiment, a cluster 110 may comprise a plurality of cluster memories 118 and these cluster memories 118 may be connected together via a router that may be downstream of the router 112.

The AIP 114 may be a special processing engine shared by all processing engines 120 of one cluster 110. In one example, the AIP 114 may be implemented as a coprocessor to the processing engines 120. For example, the AIP 114 may implement less commonly used instructions such as some floating point arithmetic, including but not limited to, one or more of addition, subtraction, multiplication, division and square root, etc. As shown in FIG. 3A, the AIP 114 may be coupled to the router 112 directly and may be configured to send and receive packets via the router 112. As a coprocessor to the processing engines 120 within the same cluster 110, although not shown in FIG. 3A, the AIP 114 may also be coupled to each processing engines 120 within the same cluster 110 directly. In one embodiment, a bus shared by all the processing engines 120 within the same cluster 110 may be used for communication between the AIP 114 and all the processing engines 120 within the same cluster 110. In another embodiment, a multiplexer may be used to control communication between the AIP 114 and all the processing engines 120 within the same cluster 110. In yet another embodiment, a multiplexer may be used to control access to the bus shared by all the processing engines 120 within the same cluster 110 for communication with the AIP 114.

The grouping of the processing engines 120 on a computing device 102 may have a hierarchy with multiple levels. For example, multiple clusters 110 may be grouped together to form a super cluster. FIG. 3B is a block diagram of an exemplary super cluster 130 according to the present disclosure. As shown on FIG. 3B, a plurality of clusters 110A through 110H may be grouped into an exemplary super cluster 130. Although 8 clusters are shown in the exemplary super cluster 130 on FIG. 3B, the exemplary super cluster 130 may comprise 2, 4, 8, 16, 32 or another number of clusters 110. The exemplary super cluster 130 may comprise a router 134 and a super cluster controller 132, in addition to the plurality of clusters 110. The router 134 may be configured to route packets among the clusters 110 and the super cluster controller 132 within the super cluster 130, and to and from resources outside the super cluster 130 via a link to an upstream router. In an embodiment in which the super cluster 130 may be used in a processing device 102A, the upstream router for the router 134 may be the top level router 104 of the processing device 102A and the router 134 may be an upstream router for the router 112 within the cluster 110. In one embodiment, the super cluster controller 132 may implement CCRs, may be configured to receive and send packets, and may implement a fixed-purpose state machine encapsulating packets and memory access to the CCRs, and the super cluster controller 132 may be implemented similar to the cluster controller 116. In another embodiment, the super cluster 130 may be implemented with just the router 134 and may not have a super cluster controller 132.

An exemplary cluster 110 according to the present disclosure may include 2, 4, 8, 16, 32 or another number of processing engines 120. FIG. 3A shows an example of a plurality of processing engines 120 been grouped into a cluster 110 and FIG. 3B shows an example of a plurality of clusters 110 been grouped into a super cluster 130. Grouping of processing engines is not limited to clusters or super clusters. In one embodiment, more than two levels of grouping may be implemented and each level may have its own router and controller.

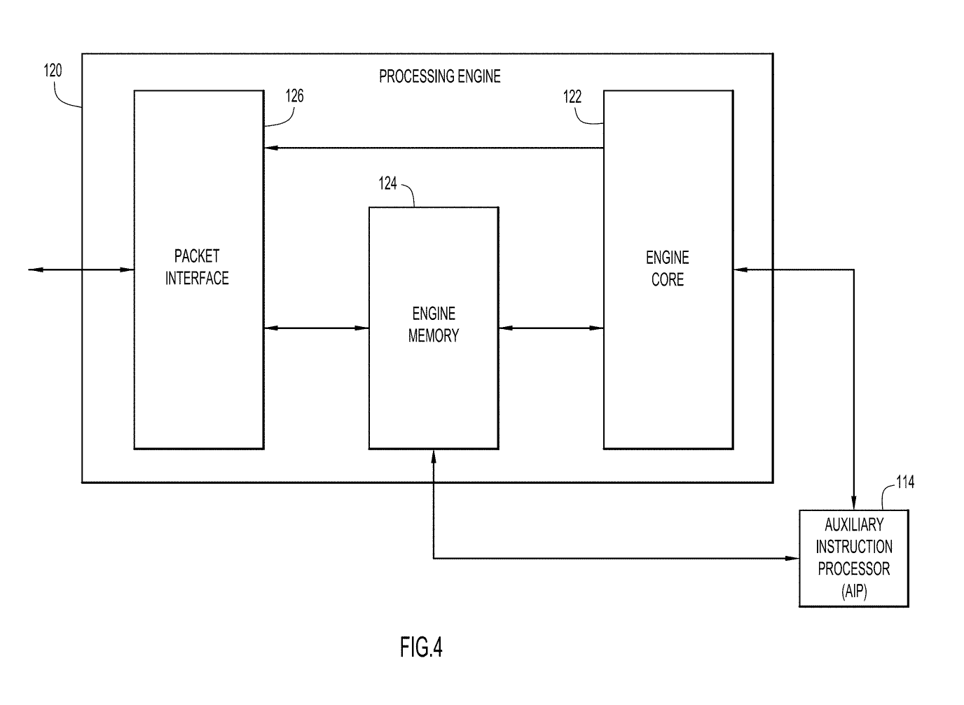

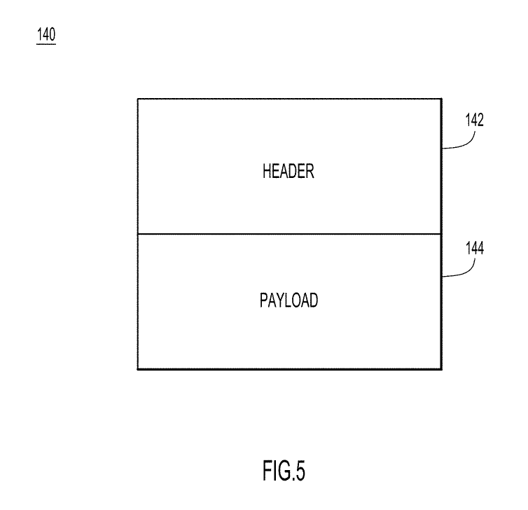

FIG. 4 shows a block diagram of an exemplary processing engine 120 according to the present disclosure. As shown in FIG. 4, the processing engine 120 may comprise an engine core 122, an engine memory 124 and a packet interface 126. The processing engine 120 may be coupled to an AIP 114. As described herein, the AIP 114 may be shared by all processing engines 120 within a cluster 110. The processing core 122 may be a central processing unit (CPU) with an instruction set and may implement some or all features of modern CPUs, such as, for example, a multi-stage instruction pipeline, one or more arithmetic logic units (ALUs), a floating point unit (FPU) or any other existing or future-developed CPU technology. The instruction set may comprise one instruction set for the ALU to perform arithmetic and logic operations, and another instruction set for the FPU to perform floating point operations. In one embodiment, the FPU may be a completely separate execution unit containing a multi-stage, single-precision floating point pipeline. When an FPU instruction reaches the instruction pipeline of the processing engine 120, the instruction and its source operand(s) may be dispatched to the FPU.

The instructions of the instruction set may implement the arithmetic and logic operations and the floating point operations, such as those in the INTEL® x86 instruction set, using a syntax similar or different from the x86 instructions. In some embodiments, the instruction set may include customized instructions. For example, one or more instructions may be implemented according to the features of the computing system 100. In one example, one or more instructions may cause the processing engine executing the instructions to generate packets directly with system wide addressing. In another example, one or more instructions may have a memory address located anywhere in the computing system 100 as an operand. In such an example, a memory controller of the processing engine executing the instruction may generate packets according to the memory address being accessed.

The engine memory 124 may comprise a program memory, a register file comprising one or more general purpose registers, one or more special registers and one or more events registers. The program memory may be a physical memory for storing instructions to be executed by the processing core 122 and data to be operated upon by the instructions. In some embodiments, portions of the program memory may be disabled and powered down for energy savings. For example, a top half or a bottom half of the program memory may be disabled to save energy when executing a program small enough that less than half of the storage may be needed. The size of the program memory may be 1 thousand (1K), 2K, 3K, 4K, or any other number of storage units. The register file may comprise 128, 256, 512, 1024, or any other number of storage units. In one non-limiting example, the storage unit may be 32-bit wide, which may be referred to as a longword, and the program memory may comprise 2K 32-bit longwords and the register file may comprise 256 32-bit registers.

The register file may comprise one or more general purpose registers for the processing core 122. The general purpose registers may serve functions that are similar or identical to the general purpose registers of an x86 architecture CPU.

The special registers may be used for configuration, control and/or status. Exemplary special registers may include one or more of the following registers: a program counter, which may be used to point to the program memory address where the next instruction to be executed by the processing core 122 is stored; and a device identifier (DEVID) register storing the DEVID of the processing device 102.

In one exemplary embodiment, the register file may be implemented in two banks—one bank for odd addresses and one bank for even addresses—to permit fast access during operand fetching and storing. The even and odd banks may be selected based on the least-significant bit of the register address for if the computing system 100 is implemented in little endian or on the most-significant bit of the register address if the computing system 100 is implemented in big-endian.

The engine memory 124 may be part of the addressable memory space of the computing system 100. That is, any storage location of the program memory, any general purpose register of the register file, any special register of the plurality of special registers and any event register of the plurality of events registers may be assigned a memory address PADDR. Each processing engine 120 on a processing device 102 may be assigned an engine identifier (ENGINE ID), therefore, to access the engine memory 124, any addressable location of the engine memory 124 may be addressed by DEVID:CLSID:ENGINE ID: PADDR. In one embodiment, a packet addressed to an engine level memory location may include an address formed as DEVID:CLSID:ENGINE ID: EVENTS:PADDR, in which EVENTS may be one or more bits to set event flags in the destination processing engine 120. It should be noted that when the address is formed as such, the events need not form part of the physical address, which is still DEVID:CLSID:ENGINE ID:PADDR. In this form, the events bits may identify one or more event registers to be set but these events bits may be separate from the physical address being accessed.

The packet interface 126 may comprise a communication port for communicating packets of data. The communication port may be coupled to the router 112 and the cluster memory 118 of the local cluster. For any received packets, the packet interface 126 may directly pass them through to the engine memory 124. In some embodiments, a processing device 102 may implement two mechanisms to send a data packet to a processing engine 120. For example, a first mechanism may use a data packet with a read or write packet opcode. This data packet may be delivered to the packet interface 126 and handled by the packet interface 126 according to the packet opcode. The packet interface 126 may comprise a buffer to hold a plurality of storage units, for example, 1K, 2K, 4K, or 8K or any other number. In a second mechanism, the engine memory 124 may further comprise a register region to provide a write-only, inbound data interface, which may be referred to a mailbox. In one embodiment, the mailbox may comprise two storage units that each can hold one packet at a time. The processing engine 120 may have a event flag, which may be set when a packet has arrived at the mailbox to alert the processing engine 120 to retrieve and process the arrived packet. When this packet is being processed, another packet may be received in the other storage unit but any subsequent packets may be buffered at the sender, for example, the router 112 or the cluster memory 118, or any intermediate buffers.

In various embodiments, data request and delivery between different computing resources of the computing system 100 may be implemented by packets. FIG. 5 illustrates a block diagram of an exemplary packet 140 according to the present disclosure. As shown in FIG. 5, the packet 140 may comprise a header 142 and an optional payload 144. The header 142 may comprise a single address field, a packet opcode (POP) field and a size field. The single address field may indicate the address of the destination computing resource of the packet, which may be, for example, an address at a device controller level such as DEVID:PADDR, an address at a cluster level such as a physical address DEVID:CLSID:PADDR or a virtual address DEVID:CLSID:ADDR, or an address at a processing engine level such as DEVID:CLSID:ENGINE ID:PADDR or DEVID:CLSID:ENGINE ID:EVENTS:PADDR. The POP field may include a code to indicate an operation to be performed by the destination computing resource. Exemplary operations in the POP field may include read (to read data from the destination) and write (to write data (e.g., in the payload 144) to the destination).

In some embodiments, the exemplary operations in the POP field may further include bulk data transfer. For example, certain computing resources may implement DMA feature. Exemplary computing resources that implement DMA may include a cluster memory controller of each cluster memory 118, a memory controller of each engine memory 124, and a memory controller of each device controller 106. Any two computing resources that implemented the DMA may perform bulk data transfer between them using packets with a packet opcode for bulk data transfer.

In addition to bulk data transfer, in some embodiments, the exemplary operations in the POP field may further include transmission of unsolicited data. For example, any computing resource may generate a status report or incur an error during operation, the status or error may be reported to a destination using a packet with a packet opcode indicating that the payload 144 contains the source computing resource and the status or error data.

The POP field may be 2, 3, 4, 5 or any other number of bits wide. In some embodiments, the width of the POP field may be selected depending on the number of operations defined for packets in the computing system 100. Also, in some embodiments, a packet opcode value can have different meaning based on the type of the destination computer resources that receives it. By way of example and not limitation, for a three-bit POP field, a value 001 may be defined as a read operation for a processing engine 120 but a write operation for a cluster memory 118.

In some embodiments, the header 142 may further comprise an addressing mode field and an addressing level field. The addressing mode field may contain a value to indicate whether the single address field contains a physical address or a virtual address that may need to be converted to a physical address at a destination. The addressing level field may contain a value to indicate whether the destination is at a device, cluster memory or processing engine level.

The payload 144 of the packet 140 is optional. If a particular packet 140 does not include a payload 144, the size field of the header 142 may have a value of zero. In some embodiments, the payload 144 of the packet 140 may contain a return address. For example, if a packet is a read request, the return address for any data to be read may be contained in the payload 144.

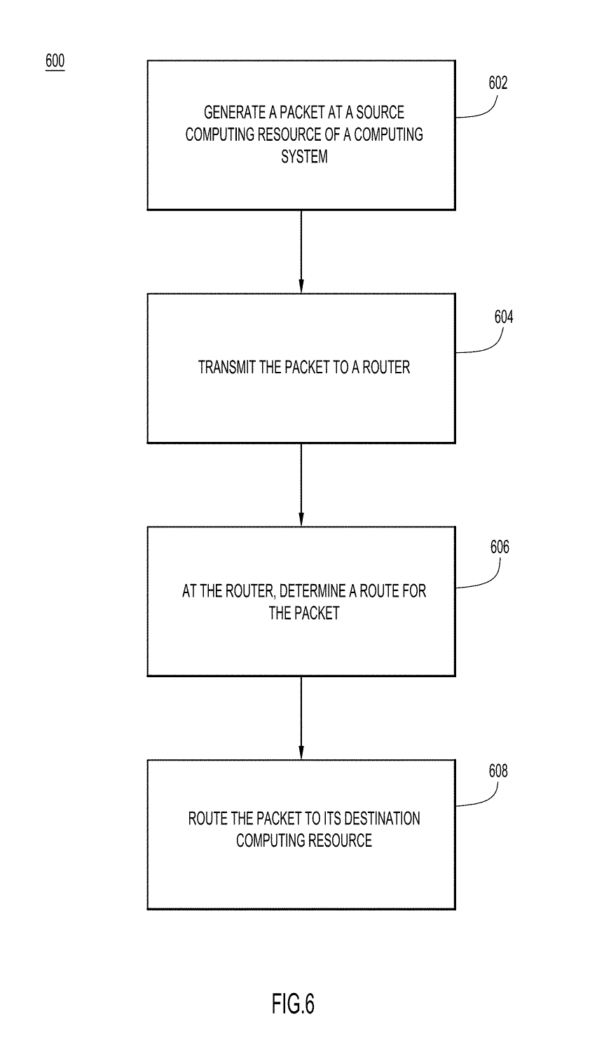

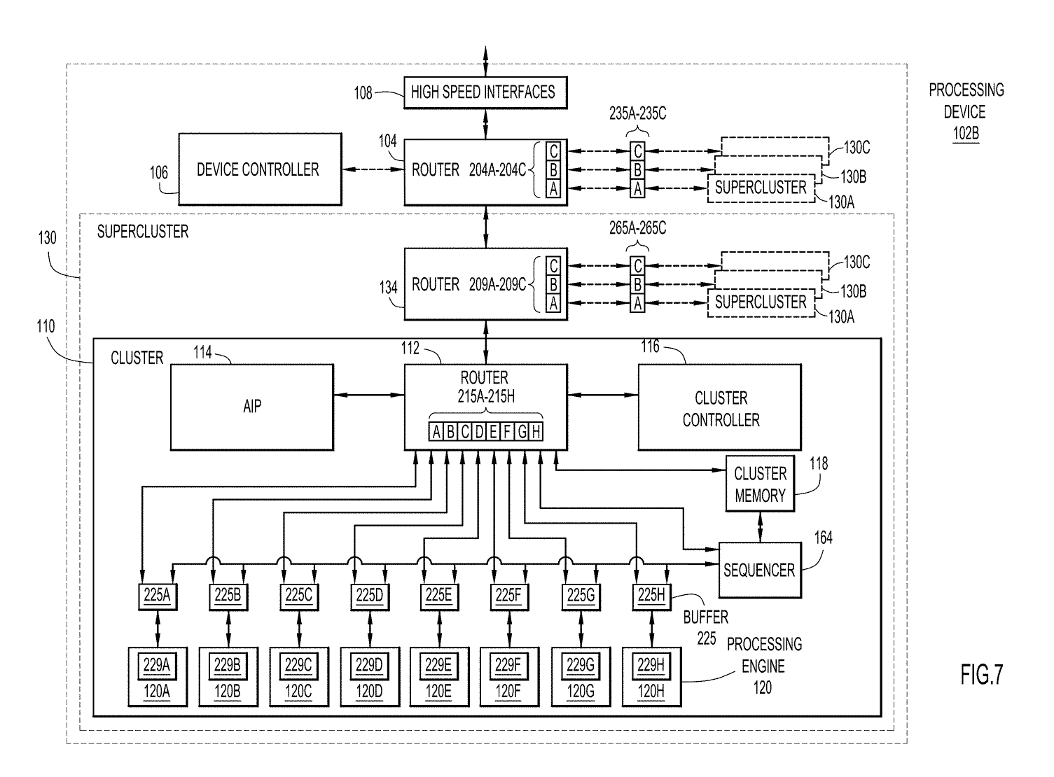

FIG. 6 is a flow diagram showing an exemplary process 600 of addressing a computing resource using a packet according to the present disclosure. An exemplary embodiment of the computing system 100 may have one or more processing devices configured to execute some or all of the operations of exemplary process 600 in response to instructions stored electronically on an electronic storage medium. The one or more processing devices may include one or more devices configured through hardware, firmware, and/or software to be specifically designed for execution of one or more of the operations of exemplary process 600.

The exemplary process 600 may start with block 602, at which a packet may be generated at a source computing resource of the exemplary embodiment of the computing system 100. The source computing resource may be, for example, a device controller 106, a cluster controller 118, a super cluster controller 132 if super cluster is implemented, an AIP 114, a memory controller for a cluster memory 118, or a processing engine 120. In one embodiment, in addition to the exemplary source computing resource listed above, a host, whether a device 102 designated the host, or a different device (such as the P_Host in system 100B), may also be the source of data packets. The generated packet may be an exemplary embodiment of the packet 140 according to the present disclosure. From block 602, the exemplary process 600 may continue to the block 604, where the packet may be transmitted to an appropriate router based on the source computing resource that generated the packet. For example, if the source computing resource is a device controller 106, the generated packet may be transmitted to a top level router 104 of the local processing device 102; if the source computing resource is a cluster controller 116, the generated packet may be transmitted to a router 112 of the local cluster 110; if the source computing resource is a memory controller of the cluster memory 118, the generated packet may be transmitted to a router 112 of the local cluster 110, or a router downstream of the router 112 if there are multiple cluster memories 118 coupled together by the router downstream of the router 112; and if the source computing resource is a processing engine 120, the generated packet may be transmitted to a router of the local cluster 110 if the destination is outside the local cluster and to a memory controller of the cluster memory 118 of the local cluster 110 if the destination is within the local cluster.

At block 606, a route for the generated packet may be determined at the router. As described herein, the generated packet may comprise a header that includes a single destination address. The single destination address may be any addressable location of a uniform memory space of the computing system 100. The uniform memory space may be an addressable space that covers all memories and registers for each device controller, cluster controller, super cluster controller if super cluster is implemented, cluster memory and processing engine of the computing system 100. In some embodiments, the addressable location may be part of a destination computing resource of the computing system 100. The destination computing resource may be, for example, another device controller 106, another cluster controller 118, a memory controller for another cluster memory 118, or another processing engine 120, which is different from the source computing resource. The router that received the generated packet may determine the route for the generated packet based on the single destination address. At block 608, the generated packet may be routed to its destination computing resource.

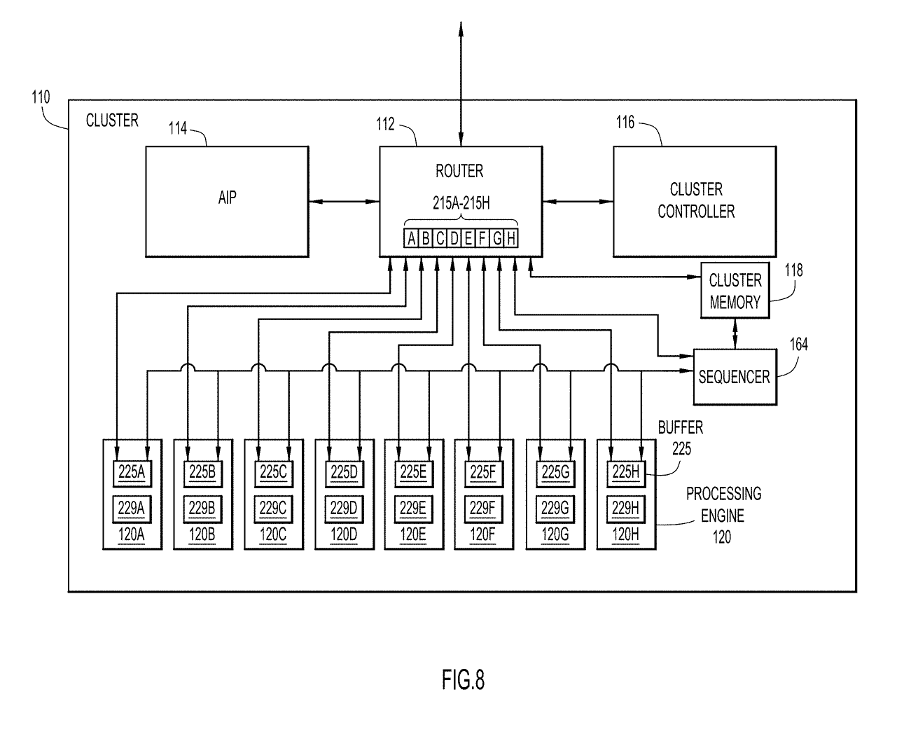

FIG. 7 illustrates an exemplary processing device 102B according to the present disclosure. The exemplary processing device 102B may be one particular embodiment of the processing device 102. Therefore, the processing device 102 referred to in the present disclosure may include any embodiments of the processing device 102, including the exemplary processing devices 102A and 120B. The exemplary processing device 102B may be used in any embodiments of the computing system 100. As shown in FIG. 7, the exemplary processing device 102B may comprise the device controller 106, router 104, one or more super clusters 130, one or more clusters 110, and a plurality of processing engines 120 as described herein. The super clusters 130 may be optional, and thus are shown in dashed lines.

Certain components of the exemplary processing device 102B may comprise buffers. For example, the router 104 may comprise buffers 204A-204C, the router 134 may comprise buffers 209A-209C, the router 112 may comprise buffers 215A-215H. Each of the processing engines 120A-120H may have an associated buffer 225A-225H respectively. FIG. 8 shows an alternative embodiment of the processing engines 120A-120H such that the buffers 225A-225H may be incorporated into its associated processing engines 120A-102H. Combinations of the implementation of cluster 110 depicted in FIGS. 7 and 8 are considered within the scope of this disclosure. Also as shown in FIGS. 7 and 8, each processing engines 120A-120H may comprise a register 229A-229H respectively. In one embodiment, each of the registers 229A-229H may be a register. In another embodiment, each of the registers 229A-229H may be a register bit. Although one register 229 is shown in each processing engine, the register 229 may represent a plurality of registers for event signaling purposes. In some implementations, all or some of the same components may be implemented in multiple chips, and/or within a network of components that is not confined to a single chip. Connections between components as depicted in FIG. 7 and FIG. 8 may include examples of data and/or control connections within the exemplary processing device 102B, but are not intended to be limiting in any way. Further, as shown in FIGS. 7 and 8, each processing engines 120A-120H may comprise a buffer 225A-225H respectively, in one embodiment, each processing engines 120A-120H may comprise two or more buffers.

As used herein, buffers may be configured to accommodate communication between different components within a computing system. Alternatively, and/or simultaneously, buffers may include electronic storage, including but not limited to non-transient electronic storage. Examples of buffers may include, but are not limited to, queues, first-in-first-out buffers, stacks, first-in-last-out buffers, registers, scratch memories, random-access memories, caches, on-chip communication fabric, switches, switch fabric, interconnect infrastructure, repeaters, and/or other structures suitable to accommodate communication within a multi-core computing system and/or support storage of information. An element within a computing system that serves a purpose as the point of origin for a transfer of information may be referred to as a source.

In some implementations, buffers may be configured to store information temporarily, in particular while the information is being transferred from a point of origin, via one or more buffers, to one or more destinations. Structures in the path from a source to a buffer, including the source, may be referred to as being upstream of the buffer. Structures in the path from a buffer to a destination, including the destination, may be referred to as being downstream of the buffer. The terms upstream and downstream may be used as directions and/or as adjectives. In some implementations, individual buffers, such as but not limited to buffers 225, may be configured to accommodate communication for a particular processing engine, between two particular processing engines, and/or among a set of processing engines. Packet switching may be implemented in store-and-forward, cut-through, or combination thereof. For example, one part of a processing device may use store-and-forwarding packet switching and another part of the same processing device may use cut-through packet switching. Individual ones of the one or more particular buffers may have a particular status, condition, and/or activity associated therewith, jointly referred to as a buffer state.

By way of non-limiting example, buffer states may include a buffer becoming completely full, a buffer becoming completely empty, a buffer exceeding a threshold level of fullness or emptiness (this may be referred to as a watermark), a buffer experiencing an error condition, a buffer operating in a particular mode of operation, at least some of the functionality of a buffer being turned on or off, a particular type of information being stored in a buffer, particular information being stored in a buffer, a particular level of activity, or lack thereof, upstream and/or downstream of a buffer, and/or other buffer states. In some implementations, a lack of activity may be conditioned on meeting or exceeding a particular duration, e.g. a programmable duration.

Conditions, status, activities and any other information related to the operating condition of components of a computing system comprising a plurality of processing devices 102 may be generated, monitored and/or collected, and tested any of various levels of the device and/or system. For example, one processing element (e.g., a processing engine) may write an unknown amount of data to some memory in a multi-chip machine. That data may be sent in one or more packets through FIFOs and buffers until it gets to its destination. While in flight, one or more FIFOs/buffers may hold part or all of the packet(s) being sent. When the packet(s) completely arrive at the destination, assuming there is no other activity in the system, all FIFOs/buffers will be empty and unallocated. Therefore, for our single processing element example, if it were possible to know the state of all FIFOs/buffers along the network or path of interest, the processing element may know that the data has “drained” out of the interconnect and arrived at its destination. In one embodiment, this may be achieved by an aggregated signal indicating those FIFOs/buffers are empty for sufficient time to cover the worst-case spacing between packets in the stream. When more processing elements and other components of a computing system are involved and more paths are being utilized, there may be more states to aggregate. That is, meaningful state indicating that interesting regions of the computing system, which may include one or more of boards, processing devices, super clusters and clusters, are empty.

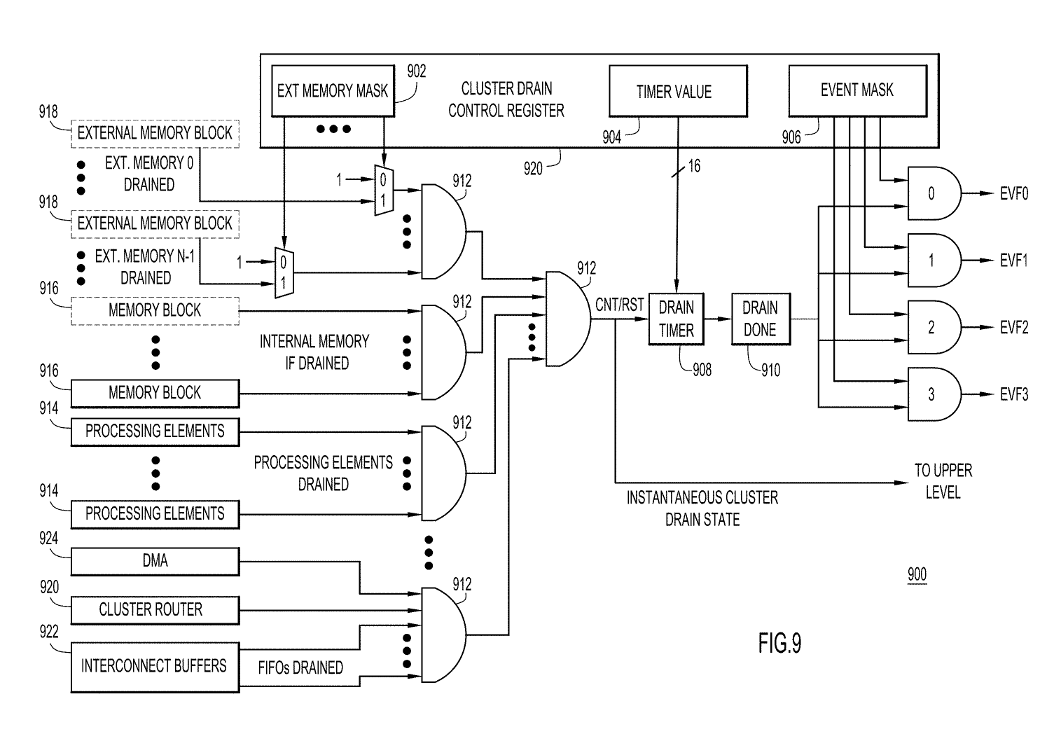

FIG. 9 illustrates an exemplary cluster 900 with drain state monitoring circuit according to the present disclosure. The cluster 900 may comprise a plurality of processing elements 914, one or more memory blocks 916, optional external memory block or blocks 918, a cluster router 920, a plurality of interconnect buffers 922 and a data sequencer 924. The cluster 900 may be an exemplary implementation of a cluster 110. For example, the plurality of processing elements 914 may be an exemplary implementation of the processing engines 120, the cluster router 920 may be an exemplary implementation of the cluster router 112, the one or more memory blocks 916 and optional external memory block or blocks 918 may be an exemplary implementation of the cluster memory 118, and the interconnect buffers 922 may be an exemplary implementation of various buffers interconnecting the components of the cluster. The interconnect buffers 922, for example, may include but not limited to, the buffers 215 and buffers 225 as described herein, and other buffers interconnecting the components of the cluster (e.g., buffers between the processing elements and memory blocks). The data sequencer 924 may be an exemplary implementation of the data sequencer 164. Although not shown, the cluster 900 may also comprise DMA engines as described above with respect to FIG. 3A.

Each of the plurality of processing elements 914 may comprise a signal line and each of the plurality of processing elements 914 may be configured to assert its respective signal line to indicate a state of the respective processing element. For example, when a processing element 914 has finished processing a piece of data assigned to it, the respective signal line may be asserted to indicate that the processing element 914 now has no data waiting to be processed or transmitted, and thus the processing element is now in a drain state. In one embodiment, the processing element 914 may assert its signal line when both inbound and outbound conditions are met. For example, for outbound condition to be met, any packet currently in the execute phase of the ALU of the processing element 914 must be completely sent. This may ensure that even if a packet associated with the instruction which is currently executing hasn't emerged into the cross connect with other processing elements 914 yet, it is taken into account. One exemplary inbound condition may be that there is no packet being clocked into the processing element 914, nor are any packets arbitrating at the processing element 914's interfaces.

Similarly, each of the one or more memory blocks 916, each of the optional external memory block or blocks 918, each of the plurality of interconnect buffers 922, the cluster router 920, the data sequencer 924 and feeder queues of the data sequencer 924 (and the DMA engine) may also comprise a signal line, and each of these components may be configured to assert its respective signal lines to indicate a state of the respective components. For some components, the signal lines may be asserted when there is no data in any interface buffers for these components. In one embodiment, the signal lines may be asserted when both outbound and inbound conditions are met, for example, all outbound FIFOs/buffers within these memory blocks are empty (including any data FIFOs/buffers at the back end of the memory blocks from which packets may be generated, so that packets about to enter the cluster interconnect are included in the drain state), and there is no packet being clocked in, nor are any packets arbitrating, at any of the inbound interfaces.

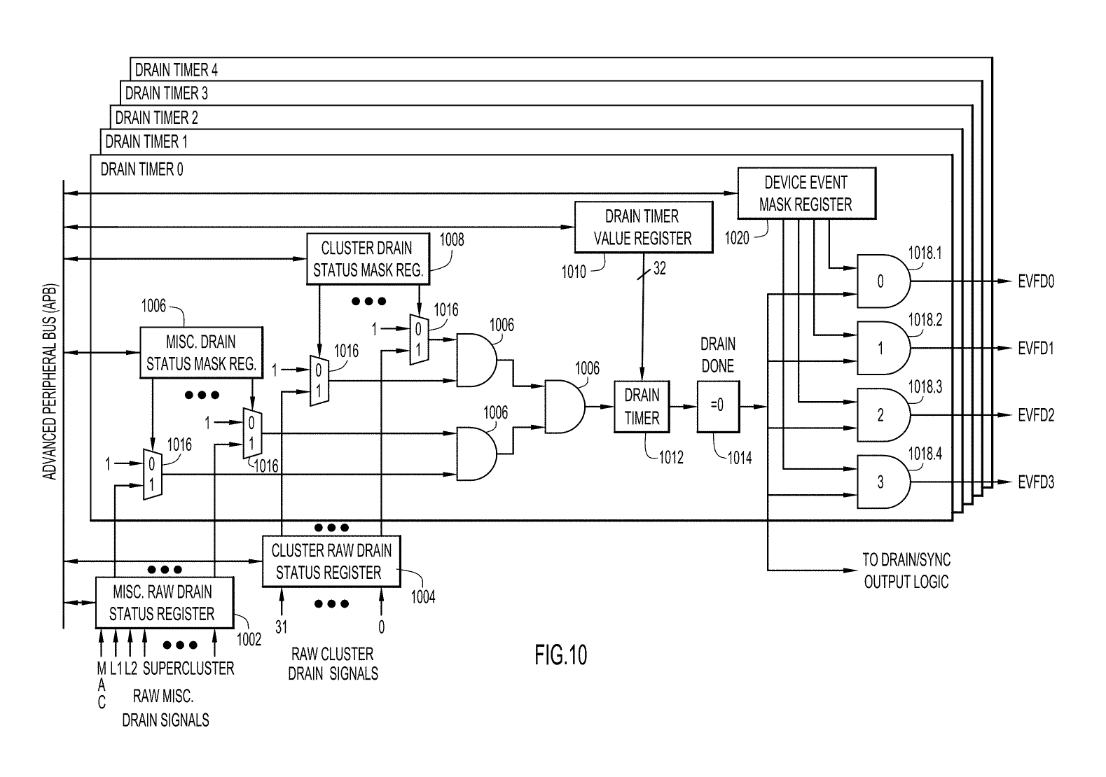

The signal lines from various components in a cluster may be coupled to a cluster state circuit 912 as inputs, such that the cluster state circuit 912 may generate an output to indicate a state of the cluster. In one embodiment, the cluster state circuit 912 may be implemented by one or more AND gates such that one asserted output may be generated when all inputs are asserted. For example, when all signal lines coupled to the inputs of the cluster state circuit 912 are asserted, the cluster state circuit 912 may generate a cluster drain condition. That is, the drain condition from all indicated areas of the cluster may be logically AND-ed together to generate a drain condition signal for the entire cluster. Therefore, a cluster's drain condition may be sourced exclusively by state within the cluster. This drain condition may be available for direct local use and also exported so that it can be aggregated at the supercluster and processing device levels. For example, the drain condition for each cluster may be individually sent up to an upper level (e.g., device controller block) and aggregated in an upper level register (e.g., the Cluster Raw Drain Status Register 1004 in FIG. 10) as discussed below.

It should be noted that inputs to the cluster state circuit 912 may be selective, that is, the signal lines of one or more components may be selected to be output to the cluster state circuit 912. For example, as shown in FIG. 9, the cluster 900 may comprise an external memory mask register 902. The external memory mask register 902 may comprise a plurality of bits such that each bit may be individually set. Each of such bits may correspond to one external memory block and a bit may be set to let the corresponding external memory block 918's outputs to be passed through to the cluster state circuit 912 (e.g., via multiplexers as shown in FIG. 9). The external memory mask register 902 is just one example and the cluster 900 may comprise one or more other mask registers in addition to or in place of the mask register 902. The one or more other mask registers may comprise one or more bits to select (e.g., via multiplexers not shown in FIG. 9) which signal lines of the various components (e.g., the memory block 016, processing elements 914, data sequencer 924 (and the feeder queues), cluster router 920, and/or interconnect buffers 922) may pass their signals to the cluster state circuit 912.

It should be noted that each processing element 914 and the data sequencer 924 may also have an execution IDLE state. In one embodiment, a processing element 914 (or data sequencer 924) may assert its signal line only when the processing element 914 (or the data sequencer 924) is in an execution IDLE state, in addition to the processing element 914 (or the data sequencer 924) may be drained. In another embodiment, a processing element 914 (or the data sequencer 924) may have a separate execution state signal line which may be asserted when the processing element 914 (or the data sequencer 924) is in an execution IDLE state, in addition to the drain state signal line for the processing element 914 (or the data sequencer 924). In a further embodiment, if both processing element (or data sequencer) drained and processing element execution (data sequencer) idle signal lines are implemented, a mask may be provided to select which of these signals may be passed through to the cluster state circuit 912.

The cluster 900 may further comprise a drain timer 908 and a timer register 904. The timer register 904 may store a time period to be set for the timer 908. The time period may be pre-determined and adjustable. In one embodiment, the drain timer 908 may start counting when the output of the cluster state circuit 912 is asserted and when the time period as set in the register 904 has passed, the drain timer 908 may generate a drain done signal to be held at an optional drain done signal storage 910 (e.g., a register or buffer). Thus, the cluster drain condition may control the drain timer 908. The timer 908 will run when the logic indicates that the cluster is drained, but will reset to the configured pre-load value if the drain state de-asserts before the timer 908 is exhausted. If the drain condition persists until the timer 908 is exhausted, the drain is completed, and one or more cluster events (e.g., EVF0, EVF1, EVF2, and/or EVF3) may be generated using the OR gates as shown in FIG. 9 depending on the cluster event mask set in the event mask register 906. In one embodiment, the external memory mask register 902, the timer register 904 and the event mask register 906 may be implemented as separate fields in a cluster drain control register 920. FIG. 9 shows that the timer register 904 may set a 16 bits value of time period, which may be an example and other embodiments may use another number of bits, such as but not limited to, 4, 8, 32, 64, etc.

FIG. 10 is a block diagram of drain state monitoring circuit 1000 for an exemplary processing device according to the present disclosure. The drain state monitoring circuit 1000 may be one of several identical and independent drain timer blocks at a processing device level. As shown in FIG. 10, an example processing device may comprise 5 such drain timer blocks and the drain state monitoring circuit 1000 may show the Drain Timer 0 in detail as an example. The drain state monitoring circuit 1000 may comprise a miscellaneous raw drain status register 1002, a cluster raw drain status register 1004, a miscellaneous drain status mask register 1006 and a cluster drain status mask register 1008. The miscellaneous raw drain status register 1002, cluster raw drain status register 1004, miscellaneous drain status mask register 1006 and cluster drain status mask register 1008 may receive their respective values from an advanced peripheral bus (APB). The cluster raw drain status register 1004 may contain the drain status of each cluster in the processing device. The miscellaneous raw drain status register 1002 may contain the drain status of each supercluster inbound and outbound port, as well as the drain status of different levels of routers outside of a cluster (e.g., the top level router 104 and supercluster level routers 134), and the drain status of the MACs for the high speed interfaces 108. The cluster drain status mask register 1008 may comprise a plurality of bits to be used (e.g., via one or more multiplexers 1016) to select which cluster drain status conditions are to be included in determining the desired drain condition. The miscellaneous drain status mask register 1006 may comprise a plurality of bits to select (e.g., via one or more multiplexers 1016) which of the router and MAC drain status conditions are to be included in determining the desired drain state.

The outputs from the multiplexers 1016 may be coupled to one or more logical AND gates 1006 as inputs, such that the one or more logical AND gates 1006 may collectively generate (e.g., aggregated in series) an output to indicate a drain condition for the selected status registers. The drain state monitoring circuit 1000 may also comprise a drain timer 1012, a drain timer value register 1010, a device event mask register 1020 and a plurality of AND gates 1018. The output of the one or more logical AND gates 1006 may be coupled to the drain timer 1012 as an input. When the logical AND of all selected drain conditions is asserted, the drain timer 1012 may begin to count down starting from a time period value loaded from the drain timer value register 1010. The time period value may be pre-determined and adjustable. If the drain condition de-asserts prior to the drain timer 1012 reaching zero, the timer 1012 may be reset, and the process starts over. Therefore, the drain condition may need to remain continuously asserted until the drain timer 1012 reaches zero to fulfil the drain criteria and assert the “drain done” signal 1014. The “drain done” signal 1014 may be coupled as one input to each of the AND gates 1018 (e.g., 1018.1, 1018.2, 1018.3 and 1018.4) respectively. Each of the AND gates 1018 may also have another input coupled to the device event mask register 1020 such that each of the AND gates 1018 may be configured to generate a device event (e.g., EVFD0, EVFD1, EVFD2, EVFD3) based on the “drain done” signal 1014 and a respective mask bit in the device event mask register 1020. In one embodiment, the device events generated based on drain state (e.g., EVFD0, EVFD1, EVFD2, EVFD3) on a processing device may be used by the processing device for synchronization.

In one embodiment, the drain timer value register 1010 and the device event mask register 1020 may be configured to receive their respective values from the advanced peripheral bus (APB) as well. Moreover, FIG. 10 shows that the drain timer value register 1010 may set a 32 bits value of time period, which is just an example and other embodiments may use another number of bits, such as but not limited to, 4, 8, 16, 64, etc.

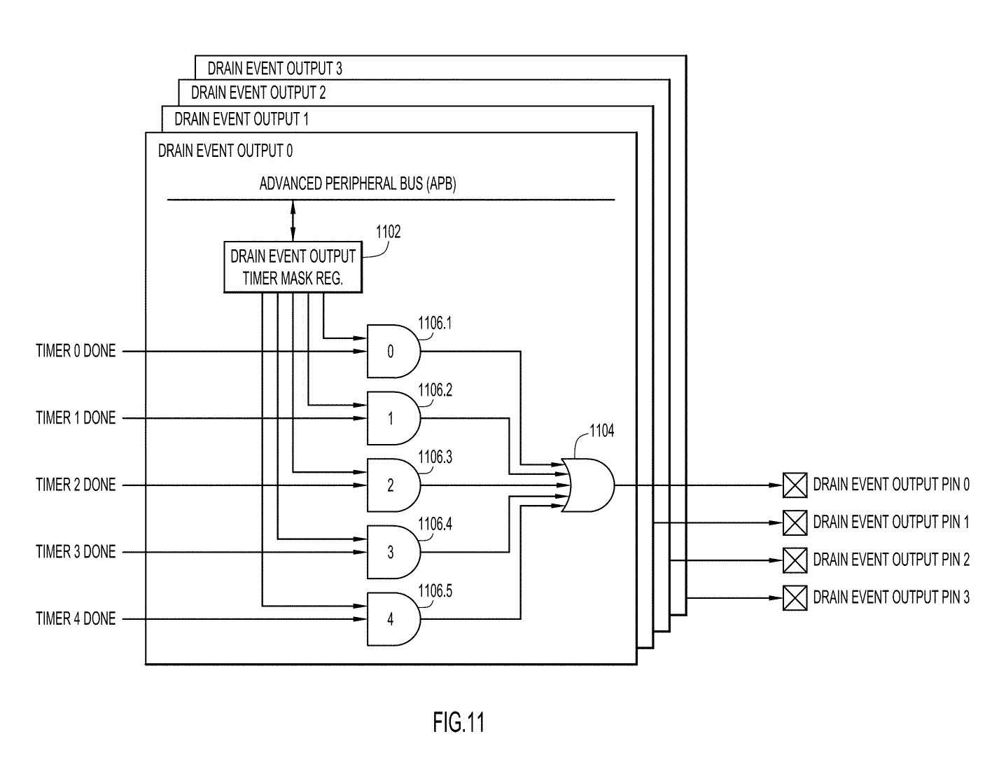

In addition to generating device events, the “drain done” signal 1014 may be used to generate sync event signals. The sync event signals may be used, at all levels of the event hierarchy, to allow synchronization and signaling. In one embodiment, the sync events may be used to provide the highest level of events which span across multiple devices. For example, in addition to being used for drain signaling (as needed by the application and the system's size), these sync event signals can also be used for non-drain synchronization/signaling. FIG. 11 is a block diagram of a drain state output circuit block 1100 for an exemplary processing device according to the present disclosure. The drain state output circuit block 1100 may be one of several identical and independent drain state output circuit blocks at a processing device level. As shown in FIG. 11, an example processing device may comprise four such drain state output circuit blocks and the drain state output circuit block 1100 may show the SYNC EVENT Output 0 in detail as an example. The drain state output circuit block 1100 may comprise a sync event output timer mask register 1102, a plurality of logical AND gates 1106 and a logical OR gate 1104. Each of the plurality of logical AND gates 1106.1, 1106.2, 1106.3, 1106.4 and 1106.5 may have one input coupled to a drain timer output (e.g., the “drain done” signal 1014) and another input coupled to a mask bit in the sync event output timer mask register 1102. Thus, the sync event output timer mask register 1102 may be used to specify which drain timer outputs will cause a particular sync event output pin to toggle, thus providing externally visible indication of the completion of one or more drain conditions. As shown in FIG. 11, the sync event output is the OR of the selected drain timer “drain done” signals. Therefore, any timer included in the mask will cause the output pin to toggle and it is not necessary for all included timers to be done to produce the output. In one embodiment, the sync event output timer mask register 1102 may be configured to receive the mask bit values from the advanced peripheral bus (APB) as well.

It should be noted that the “drain done” signal may directly cause an interrupt to the device controller processor (for example, an ARM Cortex-M0) in addition to “drain done” being able to cause device events and sync events. In a machine which uses interrupts or other signaling mechanisms rather than events, this may be another possible implementation of signaling “drain done” to report that drain is done.

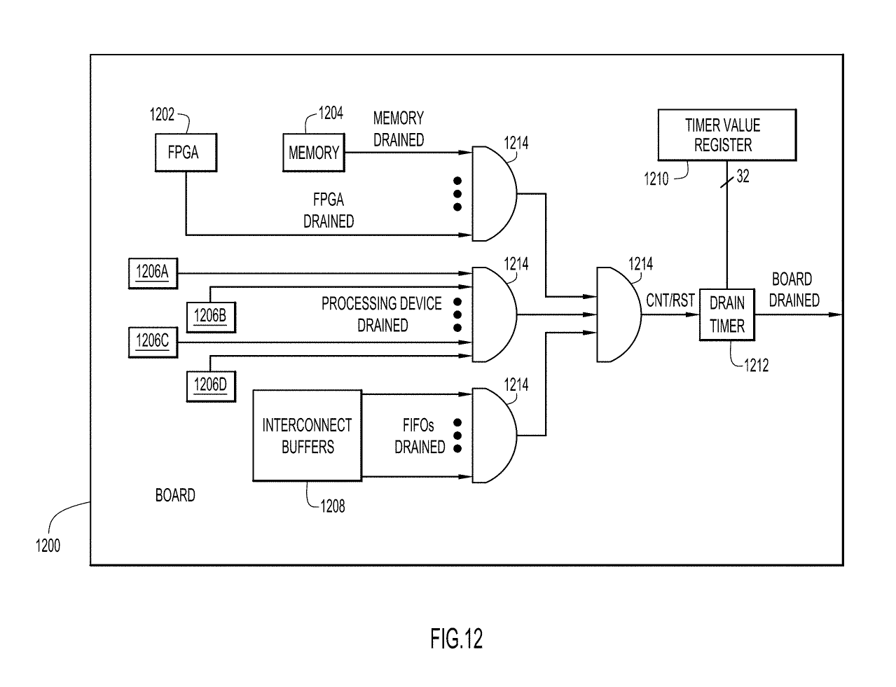

FIG. 12 is a block diagram of drain state monitoring circuit for an exemplary processing board 1200 according to the present disclosure. The exemplary processing board 1200 may comprise one or more board components, for example, a board controller (e.g., such as a FPGA 1202, an ASIC) or a network processing unit (NPU), one or more memory blocks (such as the memory block 1204), a plurality of processing devices 1206 (e.g., such as the processing devices 1206A, 1206B, 1206C and 1206D) and a plurality of interconnect buffers 1208. Each of the processing devices 1206 may be an embodiment of the processing device 102 with state monitoring circuit shown in FIGS. 9, 10 and 11. The interconnect buffers 1208 may be an exemplary implementation of various buffers interconnecting the components of the processing board 1200. Each of the FPGA 1202, memory block 1204 and the interconnect buffers 1208 may comprise a signal line that may be asserted to indicate a drain state of the respective components. Each of the plurality of processing devices 1206, however, may comprise one or more sync event outputs (e.g., the output from the OR gate 1104 shown in FIG. 11). As an example, one of such signal lines from each processing devices 1206 are shown in FIG. 12, which may be configured to indicate that the respective processing device may have been drained. The drain state signal lines from the FPGA 1202, the memory block 1204, the processing devices 1206 and interconnect buffers 1208 may be input to one or more logical AND gates 1214 such that one asserted output may be generated when all inputs are asserted.

The processing board 1200 may further comprise a drain timer 1212 which may be set to a period of time by a timer value register 1210. The time period value may be pre-determined and adjustable. The output of the one or more logical AND gates 1214 may be coupled to the drain timer 1212 as an input. The drain timer 1212 may start counting when all input signal lines are asserted. If any drain condition signal line de-asserts prior to the drain timer 1212 reaching zero, the timer 1212 may be reset, and the process starts over. Therefore, the drain condition may need to remain continuously asserted until the drain timer 1212 reaches zero to fulfil the drain criteria and assert the board drained signal line. FIG. 12 shows that the timer value register 1210 may set a 32 bits value of time period, which is an example and other embodiments may use another number of bits, such as but not limited to, 4, 8, 16, 64, etc.

It should be noted that although FIG. 12 does not show any mask registers or MUXs to select signals to be input to the AND gates 1214, in at least one embodiment, one or more mask registers and MUXs may be used to selectively determine which signals to be input to the AND gate. Moreover, in a further embodiment, more than one board level drain timer may be implemented. Each such board level drain timer may include a drain raw status register to hold drain status from various components on a board and a mask register and MUX to select which signals to be input to the AND gate. Each board level drain timer may send a “drain done” signal (e.g., output from the timer 1212) to some event logic which can mask the various drain signals (the board circuit signals, the output pins from the processing devices, etc.) to decide when to generate board level output such as sync events, interrupts, or other signaling that the condition is met.

In addition to using signal lines at cluster level, device level and/or board level as described herein to monitor whether a drain state occurred in a region being monitored, one or more internal or external interfaces may also be monitored to determine the drain state. One example would be right at the boundary of a cluster. In this example, the drain state within the cluster may be monitored, and flit packets may be coming into the cluster from outside. In addition to monitor the interconnect (buffers) and various components within the cluster, the inbound edge of the cluster may be an interface that may be provide useful information to determine the drain state. A packet that is buffered somewhere else in the device (that buffer is not monitored for drain) is trying to get into the cluster. If there are multiple sources outside of the cluster, then the interface has arbitration and will grant a request for a packet to enter the cluster. When granted, the packet may be transferred through some interface logic and into a cluster interconnect buffer (perhaps one of many buffers depending on whether the interface has some switch/router logic in it). In addition, another piece of state that could be used to test drain could be whether that cluster inbound interface has any pending requests. For example, there may be a case that the buffers in the cluster are drained and the drain timer is running, but a request arrives at the interface for a packet that has been slow to get to the cluster.

This can be extended depending on the complexity of the interface. For example, in one implementation, the supercluster-to-supercluster interface may have multiple levels of arbitration and may also have isochronous signaling due to very long distances the signals need to go. Depending on the traffic density and the length of the particular path, it could take a relatively long period for a tardy packet to make it out of one supercluster and into the cluster which is monitoring its own drain state. In this case, the drain timing may be refined if an early warning from the interface may be generated to indicate that there is an incoming packet which hasn't made it to a cluster buffer yet.

Another example might be associated with an interface between blocks within a cluster. For example, the interface between a feeder queue and the memory. Assuming that the cluster is drained based on state from all the cluster interconnect and the state of the feeder queues. But the data sequencer executed one last instruction which is the process of fetching a packet from the memory which will be delivered to the appropriate feeder queue. There are several ways drain could handle this. First, take into account the data sequencer pipeline (execution) state as described above. Second, take into account the memory logic state. If the memory is processing a read, then the memory should not report drained. In one embodiment, if the cluster drain state is fine grained, whether the activity is a read or a write may be needed. If it's a read it might be important to know which path the read data will take (e.g., maybe the path out of the cluster is not interesting). The path may be determined as the read data leaves some internal FIFO or right at an egress interface. Third, take into account the interface between the memory and each feeder queue. As soon as the memory indicates that it has a packet for a feeder queue then that feeder queue can report that it is no longer drained.

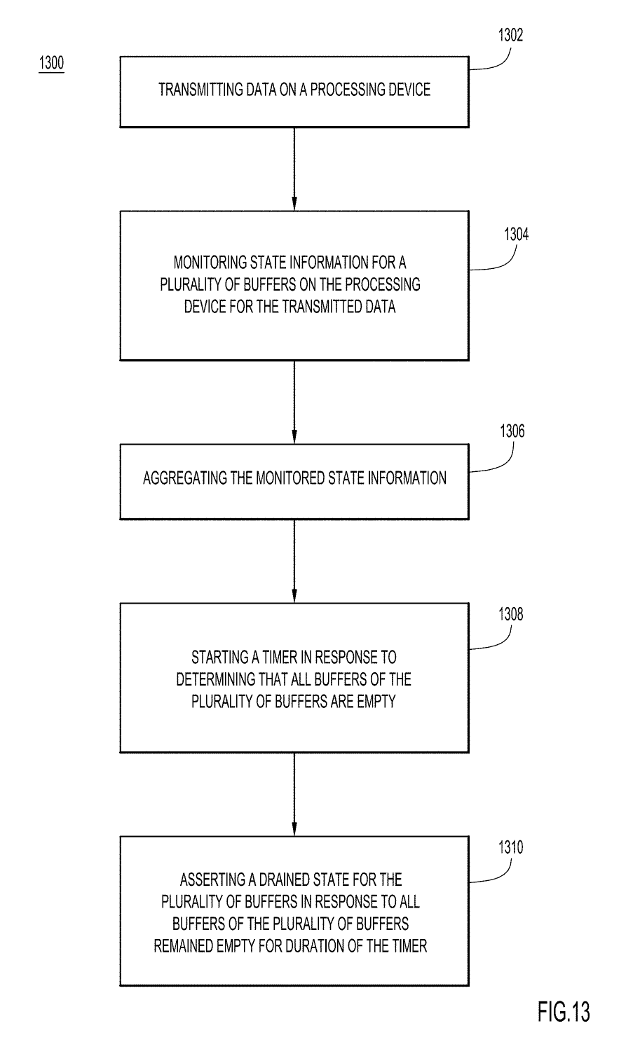

FIG. 13 is a flow diagram showing an exemplary process 1300 of monitoring drain state information for a network of interest according to the present disclosure. An exemplary embodiment of the computing system 100 may have one or more computing devices (including any embodiments of processing devices described herein) configured to execute some or all of the operations of exemplary process 1300 in response to instructions stored electronically on an electronic storage medium. The one or more computing devices may include one or more devices configured through hardware, firmware, and/or software to be specifically designed for execution of one or more of the operations of exemplary process 1300.

The exemplary process 1300 may start with block 1302, at which data may be transmitted in a computing system. For example, one or more packets containing the data to be transmitted may be generated at a source computing resource of the exemplary embodiment of the computing system 100. The source computing resource may be, for example, a device controller 106, a cluster controller 118, a super cluster controller 132 if super cluster is implemented, an AIP 114, a memory controller for a cluster memory 118, a processing engine 120, or a host in the computing system (e.g., P_Host in system 100B). The generated packets may be an exemplary embodiment of the packet 140 according to the present disclosure.

At block 1304 state information for a plurality of circuit components in the computing system may be monitored for the transmitted data. For example, the one or more packets carrying the transmitted data may be transmitted across clusters, superclusters, processing devices, processing boards. A network of interest may be determined, for example, based on source and destination of the transmitted data or where the transmitted data may pass through. The signal lines of the circuit components within the network of interest that may indicate drain state information may be monitored. For example, the signal lines for processing elements, cluster routers, interconnect buffers within clusters, memory blocks within clusters, supercluster routers and controllers, device level routers and controllers, board controllers, board memory blocks, board interconnect buffers may be monitored for the network of interest.

At block 1306, the monitored state information may be aggregated and at block 1308 a timer may be started in response to determining that all circuit components being monitored are empty. At block 1310, a drain state may be asserted in response to unmasked drain conditions of the plurality of drain conditions from circuit components remaining asserted for the duration of the timer. For example, data may be transmitted from a first processing element in a first cluster of a first processing device to a second processing element in a second cluster of a second processing device. Along the path of the transmitted data, a drain region may be any region within a network of interest. For example, the network of interest may comprise the first processing device and the second processing device. The drain region may be any region within the network of interest, for example, the first cluster, the second cluster, the supercluster comprising the first cluster, the supercluster comprising the second cluster, the first processing device, the second processing device, a board hosting the first processing device, or a region comprising both the first processing device and the second processing device.

In some embodiments, the timer (e.g., drain timer 908, drain timer 1012, drain timer 1212) may be used to make sure that if there are relatively brief gaps in the stream of packets, the gaps do not cause a false-positive drain indication. For example, if something on the order of millions of packets are being sent in a bounded portion of an application, but the stream of packets can be non-uniform so that there could be spurts followed by some relatively brief dead periods, embodiments according to the present disclosure may avoid incorrectly triggering the drain signal by the dead period. The timer value may be configured so that it spans a period of time which is greater than what is determined to be the longest dead period expected (or calculated) in the packet stream. That is, timer(s) may be set to a value that is sufficient to span a period greater than the worst-case gap between packets of a bounded packet stream being monitored. If, however, the packet stream happens to be very uniform and constant, then the timer may be configured to a very short period of time, since gaps would never or only briefly be seen.

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of microprocessors, microcontrollers, field programmable gate arrays (FPGAs), application specific integrated circuits (ASICs), and/or System on a Chip (SoC)—but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

What is claimed is:

1. A processing device, comprising:
a plurality of processing elements organized into a plurality of clusters, a first cluster of the plurality of clusters comprising:
a plurality of interconnect buffers coupled to a subset of the plurality of processing elements within the first cluster, each interconnect buffer having a respective interconnect buffer signal line and being configured to assert the respective interconnect buffer signal line to indicate a state of the respective interconnect buffer;
a cluster state circuit having inputs coupled to the interconnect buffer signal lines and an output indicating a state of the first cluster; and
a cluster timer with an input coupled to the output of the cluster state circuit, the cluster timer being configured to (i) start counting when all buffers of the plurality of interconnect buffers become empty, and (ii) assert a drain state when all buffers of the plurality of interconnect buffers remain empty for a duration of the cluster timer.

2. The processing device of claim 1, wherein the first cluster further comprises one or more of:
a subset of the plurality of processing elements each having a respective processing element signal line and each configured to assert the respective processing element signal line to indicate a state of the respective processing element;
a memory block shared by the subset of the plurality of processing elements of the first cluster, the memory block having a memory block signal line and configured to assert the memory block signal line to indicate a state of the memory block;
a cluster router coupled to the subset of the plurality of processing elements and the memory block, the cluster router having a cluster router signal line and configured to assert the cluster router signal line to indicate a state of the cluster router;
a cluster controller coupled to the cluster router, the cluster controller having a cluster controller signal line and configured to assert the cluster controller signal line to indicate a state of the cluster controller; or
a data sequencer coupled, at a first side to the subset of the plurality of processing elements, and at a second side to the memory block, the data sequencer having a data sequencer signal line and configured to assert the data sequencer signal line to indicate a state of the data sequencer.

3. The processing device of claim 2, wherein the first cluster comprises a plurality of memory blocks, and each memory block of the plurality of memory blocks has a respective memory block signal line.

4. The processing device of claim 2, wherein each processing element of the plurality of processing elements has an execution state signal line indicating an execution state of a respective processing element.

5. The processing device of claim 4, further comprising a mask for selecting a processing element signal line, an execution state signal line, or both being counted for a cluster state.

6. The processing device of claim 2, wherein the data sequencer comprises an execution state signal line indicating an execution state of the data sequencer.

7. The processing device of claim 6, further comprising a mask for selecting the data sequencer signal line, the data sequencer execution signal line, or both being counted for a cluster state.

8. The processing device of claim 2, further comprising one or more masks for selecting one or more of the processing element signal lines, the memory block signal line, the cluster router signal line, the cluster controller signal line, and the data sequencer signal line.

9. The processing device of claim 1, wherein the cluster timer is configured with an adjustable value.

10. The processing device of claim 1, wherein the first cluster further comprises a cluster event mask that controls a cluster event generated based on the output of the cluster timer.

11. The processing device of claim 1, further comprising a drain timer at a device level, the drain timer comprising:
a first status register to hold state information for the plurality of clusters; and
a first mask register that selects a portion of the state information for the plurality of clusters to output to a drain state circuit.

12. A method of operating a processing device, comprising:
transmitting data on the processing device;
monitoring state information for a plurality of buffers on the processing device;
determining that a drain condition is satisfied using the state information for the plurality of buffers;
starting a timer in response to determining that the drain condition is satisfied; and
asserting a drain state in response to the drain condition remaining satisfied for a duration of the timer.

13. The method of claim 12, further comprising:
determining that the drain condition is not satisfied; and
resetting the timer.

14. The method of claim 12, further comprising generating cluster events based on the asserted drain state and a cluster event mask of the cluster.

15. The method of claim 12, further comprising:
monitoring state information for at least one of a memory block, a plurality of processing elements, a cluster router, a cluster controller, or a data sequencer on the processing device, wherein determining that the drain condition is satisfied further comprises using the monitored state information for the at least one of the memory block, the plurality of processing elements, the cluster router, the cluster controller, or the data sequencer.

16. The method of claim 15, further comprising:
monitoring execution state information for the plurality of processing elements and the data sequencer, wherein determining that the drain condition is satisfied further comprises using at least one mask to select which monitored execution state information contributes to the drain condition.

17. The method of claim 15, wherein determining that the drain condition is satisfied further comprises using at least one mask to select which monitored state information contributes to the drain condition.

18. The method of claim 12, further comprising:
monitoring drain state information from a plurality of clusters at a device level; and
toggling a drain sync event signal based on the monitored drain state information being asserted for a duration of a device timer.

19. The method of claim 12, further comprising generating device events based on the asserted drain state using a device event mask in one of a plurality of drain timers.

20. The method of claim 12, further comprising monitoring one or more interfaces at a boundary of a region of interest and/or between different components within the region of interest, wherein determining that the drain condition is satisfied further comprises using state information obtained by monitoring the one or more interfaces.

21. An apparatus comprising:
means for transmitting data on the apparatus;
means for monitoring state information for a plurality of buffers on the apparatus;
means for determining that a drain condition is satisfied using the state information for the plurality of buffers;
means counting a time period in response to determining that the drain condition is satisfied; and
means for asserting a drain state in response to the drain condition remaining satisfied for a duration of the time period.
